(19) United States
(12) Patent Application Publication
(10) Pub. No.: US 2008/0120134 A1
(43) Pub. Date: May 22, 2008

(54) Data Transfer Method

(75) Inventor: Lothar Strolo, Detmold (DE)

Correspondence Address: COHEN, PONTANI, LIEBERMAN & PAVANE, 551 FIFTH AVENUE, SUITE 1210, NEW YORK, NY, 10176, US

(73) Assignee: Maquet telemedicine GmbH, Detmold (DE)

(21) Appl. No.: 11/664,033

(22) PCT Filed: Sep. 23, 2005
(86) PCT No.: PCT/DE05/01685

§ 371 Date: Mar. 28, 2007

(30) Foreign Application Priority Data
Sep. 29, 2004 (DE) 102004047832.5
Oct. 19, 2004 (DE) 102004051050.4

(51) Int. Cl. G06Q 50/00

(52) U.S. Cl. 705/2

(57) ABSTRACT

Presented is a method of transferring data for medical image processing. The method includes providing at least two computers in communication with a computer network, and transferring in real-time screen contents of one of the at least two computers to the other of the at least two computers. The method further includes transferring in real-time screen contents of the other of the at least two computers to the one of the at least two computers. The method still further includes providing one or more programs configured to process the screen contents of the at least two computers in communication with the computer network.

The invention pertains to a data transfer method, especially for medical image processing methods, between at least two computers.

The image information consists of digital data files produced by modern radiological methods such as nuclear spin tomography, computer tomography, ultrasound, and even x-ray diagnostics. These files are processed and stored in local networks such as RIS (Radiology Information Systems) or PACS (Picture Archiving and Communications Systems).

Further processing and analysis by physicians take place at special digital diagnostic workstations. If, for example, the family doctor does not have the ability to receive the data for images prepared in the hospital and to process them digitally, it is necessary to prepare paper or film copies, which is expensive and time-consuming.

If, however, the hospital and the family doctor already have digital processing systems, then a data transfer can take place via storage media or a computer network. There is the problem, however, that the files of the DICOM (Digital Imaging and Communications in Medicine) format, which is the format most often used, are extremely large especially for diagnostics, which leads to extremely long storage and/or transfer times.

The time expenditure and the associated waiting time for the data to be transferred over standard internet connections, e.g., DSL, is usually in the range of 20-60 minutes, depending on the type and size of the images.

If, in addition, the users of the minimum of two spatially separate computers, such as a doctor and a radiologist, want to analyze an image interactively with each other, they will find that this is hardly practicable because of the length of time it takes to transmit large data files over conventional networks.

Against this technical background, the invention has the goal of making available a data transfer method which allows a very rapid, interactive data exchange between at least two computers.

For data transfer of the type indicated above, this technical problem is solved by transferring the screen contents in real time.

In the form of their pure screen content, high-resolution digital images suitable for diagnosis in particular can be made available extremely quickly to the connected computers at different locations over all known networks. This is true completely independently of the hardware and software being used at the individual workplaces.

The data transfer preferably takes place between all computers logged onto a network, which means that the data exchange therefore takes place at least bidirectionally between two computers over an existing network connection.

Through the inventive approach of transmitting only the screen contents of the doctor's workstation and the changes made during processing, the quantity of data to be transmitted is significantly reduced in comparison with the size of the raw data files.

As a result, evaluations can be easily carried out in common, because changes to an image on a computer screen are basically available immediately to all of the other connected computers logged onto the network, which means that in fact an interaction between the participants is possible, even though they may be using different programs on the computers logged onto the network.

The method can be used at computer workstations especially approved for radiological analysis under the X-Ray Act without losing their approval as a result.

On the other hand, there is no problem at all in using the method on standard PCs and/or laptops.

The software being used with the content to be transmitted is also freely selectable. The data content does not have to be exclusively radiological data.

The method takes into account the data security guidelines imposed by law with respect to the transmission of patient-related data (security against eavesdropping).

1.-5. (canceled)

6. A method of transferring data for medical image processing, comprising:
providing at least first and second computers in communication with a computer network;
generating an image on a screen of the first computer based on a data file of medical image information; and
transferring in real-time screen contents of the image on the first computer to the second computer, whereby the image is immediately available at each of the first and second computers for interactive analysis by remotely located viewers at the first and second computers.

7. The method according to claim 1, further comprising transferring in real-time screen contents of the second computer to the first computer.

8. The method according to claim 1, wherein the data transfer takes place between each of the at least first and second computers in communication with the computer network.

9. The method according to claim 1, further comprising providing one or more programs configured to process the screen contents of the at least first and second computers in communication with the computer network.

10. The method according to claim 1, wherein the screen contents that are transferred are of a quality that is medically relevant for diagnosis or evaluation.

11. The method according to claim 1, wherein the at least first and second computers are approved diagnostic workstations, such that medical diagnosis is possible at these stations.
